(19) United States
(12) Patent Application Publication
(10) Pub. No.: US 2026/0016406 A1
(43) Pub. Date: Jan. 15, 2026

(54) POLYMER MONITORING DEVICE AND METHOD USING TERAHERTZ WAVES

(71) Applicant: IUCF-HYU (INDUSTRY-UNIVERSITY COOPERATION FOUNDATION HANYANG UNIVERSITY), Seoul (KR)

(72) Inventors: Hak Sung KIM, Seoul (KR); Sang II KIM, Seoul (KR); Dong Woon PARK, Seoul (KR); Heon Su KIM, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/337,149

(22) Filed: Sep. 23, 2025

Related U.S. Application Data
(63) Continuation of application No. PCT/KR2023/017459, filed on Nov. 3, 2023.

(30) Foreign Application Priority Data
Mar. 30, 2023 (KR) 10-2023-0041667

(51) Int. Cl. G01N 21/3581; G01B 11/06; G01N 21/41

(52) U.S. Cl. CPC G01N 21/3581; G01B 11/06; G01N 21/4133

(57) ABSTRACT

A polymer monitoring device using terahertz waves is provided. The polymer monitoring device using terahertz waves comprises: an emitter for generating terahertz waves toward a polymer layer; a detector for detecting terahertz waves generated by the emitter and passing through the polymer layer or terahertz waves generated by the emitter and reflected from the surface of the polymer layer; and a monitoring unit which, while the polymer layer is curing, simultaneously monitors the crystallinity and moisture absorption status of the polymer layer in real time on the basis of terahertz wave parameter data calculated by means of the terahertz waves detected by the detector, wherein the terahertz wave parameter data may include a terahertz wave relative amplitude (Eᵣ) and a peak amplitude ratio (\tilde{E}ᵣ) calculated through equation 1 below.

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Here, the E₀ is a time domain amplitude or frequency domain amplitude of the terahertz waves before the polymer layer absorbs moisture, the Eₜ is a time domain amplitude or frequency domain amplitude of the terahertz waves having passed through the polymer layer that has absorbed moisture, the \tilde{B}_{high} is a peak amplitude in a high frequency domain of a frequency domain signal of the terahertz waves having passed through the polymer layer, and \tilde{B}_{low} is a peak amplitude in a low frequency domain.

### CROSS-REFERENCE TO RELATED APPLICATIONS

This application s a continuation application of International Application No. PCT/KR2023/017459 filed on Nov. 3, 2023 which claims priority to Korean Patent Application No. 10-2023-0041667, filed on Mar. 30, 2023, the disclosures of each being incorporated by reference herein in their entireties.

### TECHNICAL FIELD

The present invention relates to a polymer monitoring device and method using terahertz waves, and more specifically, to a polymer monitoring device and method using terahertz waves which, while a polymer is being cured, may simultaneously monitor the crystallinity and moisture absorption status of the polymer in real time.

### BACKGROUND ART

A polymer is a material used in a variety of industrial fields. For example, a polymer applied to a semiconductor field is coated on a substrate through spin coating or the like and then subjected to a curing process to form a functional layer.

However, conventionally, it was not possible to measure or confirm the cured state of the polymer in real time during the process of coating the polymer.

In other words, conventionally, it was possible to confirm the state of the polymer only after the polymer is completely cured. Accordingly, even if an abnormality occurs in a material or equipment during a process for forming a polymer layer, it was not possible to take an immediate measure, thus causing a problem in which product defects frequently occurred.

In addition, conventionally, as the cured state of the polymer is confirmed after the polymer is completely cured, there was a problem in which a time for process completion is delayed, and as the cured state of the polymer is confirmed through a physical means, there was a concern that the formed polymer layer may be damaged.

Meanwhile, in addition to the degree of curing, the polymer may have defects due to a change in physical properties according to a moisture absorption status.

Here, methods capable of measuring the moisture of the polymer include a conductivity measuring method and a weight measuring method. However, the conductivity measuring method may detect only moisture on a surface with low accuracy, and the weight measuring method has a limitation in that a moisture status of a specific part may not be inspected.

### DISCLOSURE

### Technical Problem

One technical object of the present invention is to provide a polymer monitoring device and method using terahertz waves which, while a polymer is being cured, may simultaneously monitor the crystallinity and moisture absorption status of the polymer in real time.

The technical problems to be solved by the present invention is not limited to the above-described problems.

### Technical Solution

In order to solve the above-described technical problems, the present invention may provide a polymer monitoring device using terahertz waves.

According to one embodiment, the polymer monitoring device using terahertz waves may include: an emitter for generating terahertz waves toward a polymer layer; a detector for detecting terahertz waves generated by the emitter and passing through the polymer layer or terahertz waves generated by the emitter and reflected from the surface of the polymer layer; and a monitoring unit which, while the polymer layer is being cured, simultaneously monitors the crystallinity and moisture absorption status of the polymer layer in real time on the basis of terahertz wave parameter data calculated by the terahertz waves detected by the detector, in which the terahertz wave parameter data may include a terahertz wave relative amplitude (Eᵣ) and a peak amplitude ratio (\tilde{E}ᵣ) calculated through equation 1 below.

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Here, the E₀ may be a time domain amplitude or frequency domain amplitude of the terahertz waves before the polymer layer absorbs moisture, the Eₜ may be a time domain amplitude or frequency domain amplitude of the terahertz waves having passed through the polymer layer that has absorbed moisture, the \tilde{B}_{high} may be a peak amplitude in a high frequency domain of a frequency domain signal of the terahertz waves having passed through the polymer layer, and \tilde{B}_{low} may be a peak amplitude in a low frequency domain.

According to one embodiment, the emitter and the detector may be provided to be operable in any one measurement mode of a transmission mode, a reflection mode, and a multi-mode in which the transmission mode and the reflection mode are combined, based on an optical path of the terahertz wave for the polymer layer.

According to one embodiment, at least one emitter and at least one detector may be provided such that the number of emitters corresponds to the number of detectors.

According to one embodiment, the emitter and the detector may target a single pixel or a plurality of pixels among the pixels partitioned on the polymer layer, in which when the plurality of pixels are targeted, the plurality of pixels may be scanned.

According to one embodiment, the terahertz wave may be provided as a pulsed type or a continuous wave type.

According to one embodiment, a frequency of the terahertz wave may be 0.1 THz to 10 THz.

According to one embodiment, a thickness measuring unit may be further included, and the thickness measuring unit may measure a thickness of the polymer layer in a non-contact manner. According to one embodiment, the thickness measuring unit may photograph a side surface of the polymer layer through a camera and analyze a side surface picture of the photographed polymer layer to measure a thickness of the polymer layer.

According to one embodiment, the monitoring unit may monitor whether a curing process for the polymer layer is in a normal process by further considering optical physical property data of the polymer layer calculated through the terahertz wave detected by the detector and thickness information of the polymer layer measured by the thickness measuring unit.

According to one embodiment, the optical property data of the polymer layer may include a refractive index (η) of the polymer layer and an extinction coefficient of the polymer layer.

According to one embodiment, a database may be further included, in which the database may store the terahertz wave parameter data for each process condition and the optical property data of the polymer layer, and the monitoring unit may extract terahertz wave parameter data and optical property data for a reference polymer layer having the same process as that of a polymer layer, which is currently in a curing process, from the database, and may compare the extracted terahertz wave parameter data and optical property data for the reference polymer layer with the calculated terahertz wave parameter data or optical property data for the polymer layer to simultaneously monitor the crystallinity and moisture absorption status of the polymer layer.

Meanwhile, the present invention may provide a polymer monitoring method using terahertz waves.

According to one embodiment, the polymer monitoring method using terahertz waves may include: generating terahertz waves toward a polymer layer; detecting terahertz waves passing through the polymer layer or terahertz waves reflected from a surface of the polymer layer; and while the polymer layer is being cured, simultaneously monitoring the crystallinity and moisture absorption status of the polymer layer in real time on the basis of terahertz wave parameter data calculated by the terahertz waves detected by the detecting of the terahertz waves, in which the terahertz wave parameter data may include a terahertz wave relative amplitude (Eᵣ) and a peak amplitude ratio (\tilde{E}ᵣ) calculated through equation 1 below.

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Here, the E₀ may be a time domain amplitude or frequency domain amplitude of the terahertz waves before the polymer layer absorbs moisture, the Eₜ may be a time domain amplitude or frequency domain amplitude of the terahertz waves having passed through the polymer layer that has absorbed moisture, the \tilde{B}_{high} may be a peak amplitude in a high frequency domain of a frequency domain signal of the terahertz waves having passed through the polymer layer, and \tilde{B}_{low} may be a peak amplitude in a low frequency domain.

According to one embodiment, the measuring of the thickness of the polymer layer may be further included, in which the measuring of the thickness of the polymer layer may include photographing a side surface of the polymer layer and analyzing a side surface picture of the photographed polymer layer to measure a thickness of the polymer layer.

According to one embodiment, the monitoring may include monitoring whether a curing process for the polymer layer is in a normal process by further considering optical physical property data of the polymer layer calculated through the terahertz wave detected by the detecting of the terahertz wave and the thickness information of the polymer layer measured by the measuring of the thickness of the polymer layer.

### Advantageous Effects

According to embodiments of the present invention, it can include: an emitter for generating terahertz waves toward a polymer layer; a detector for detecting terahertz waves generated by the emitter and passing through the polymer layer or terahertz waves generated by the emitter and reflected from the surface of the polymer layer; and a monitoring unit which, while the polymer layer is being cured, simultaneously monitors the crystallinity and moisture absorption status of the polymer layer in real time on the basis of terahertz wave parameter data calculated by the terahertz waves detected by the detector, in which the terahertz wave parameter data can include a terahertz wave relative amplitude (Eᵣ) and a peak amplitude ratio (\tilde{E}ᵣ) calculated through equation 1 below.

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Accordingly, a polymer monitoring device and method using terahertz waves which, while a polymer is being cured, can simultaneously monitor the crystallinity and moisture absorption status of the polymer in real time, can be provided, thus immediately coping with a problem in the polymer curing process, such as an abnormality in the polymer or an abnormality in curing equipment.

In other words, according to embodiments of the present invention, it can be possible to confirm in real time whether curing needs to be further performed or less performed, or whether moisture is excessive during the process, thus taking active measures to improve a yield during the process.

### DESCRIPTION OF DRAWINGS

The patent or application file of this patent contains at least one drawing executed in color. Copies of this patent with color drawing(s) will be provided by the Patent and Trademark Office upon request and payment of the necessary fee.

FIG. 1 is a schematic view schematically showing a polymer monitoring device according to one embodiment of the present invention.

FIG. 2 is a configuration view showing a polymer monitoring device according to one embodiment of the present invention.

FIG. 3 is a schematic view schematically showing a polymer monitoring device according to one modified embodiment of the present invention.

FIG. 4 is a schematic view schematically showing a polymer monitoring device according to another modified embodiment of the present invention.

FIG. 5 is a graph showing a relationship between time and terahertz wave amplitude.

FIG. 6 is a graph showing a relationship between a frequency of terahertz wave and an amplitude of terahertz wave for each crystallinity of PET.

FIG. 7 is a graph showing a relationship between time and moisture content for each crystallinity of PET.

FIG. 8 is a graph showing a relationship between time and terahertz wave relative amplitude for each crystallinity of PET.

FIG. 9 is a graph showing a relationship between time and peak amplitude ratio for each crystallinity of PET.

FIGS. 10 and 11 are graphs showing a relationship between terahertz wave relative amplitude and peak amplitude ratio for each crystallinity of PET.

FIG. 12 is a graph showing a relationship between time and relative index for each crystallinity of PET.

FIG. 13 is a graph showing a relationship between time and extinction coefficient for each crystallinity of PET.

FIG. 14 is a graph showing a relationship between relative index and extinction coefficient for each crystallinity of PET.

FIG. 15 is a flowchart of a polymer monitoring method using terahertz waves according to one embodiment of the present invention in the order of processes.

### BEST MODE

Hereinafter, preferred embodiments of the present invention will be described in detail with reference to the accompanying drawings. However, the technical spirit of the present invention is not limited to the embodiments described herein and may be implemented in other forms. Rather, the embodiments introduced herein are provided so that the disclosed contents may be thorough and complete and the spirit of the present invention may be sufficiently conveyed to those skilled in the art.

In this specification, when a component is referred to as being on another component, it means that it may be formed directly on the other component or a third component may be interposed therebetween. In addition, in the drawings, shapes and sizes are exaggerated for effective description of the technical contents.

Furthermore, in various embodiments of the present specification, terms such as first, second, third, etc., are used to describe various components, but these components should not be limited by these terms. These terms have only been used to distinguish one component from another component. Accordingly, a component mentioned as a first component in one embodiment may be mentioned as a second component in another embodiment. Each embodiment described and exemplified herein includes a complementary embodiment thereof. In addition, in the present specification, “and/or” is used as a meaning including at least one of the components listed before and after.

In the specification, a singular expression includes a plural expression unless the context clearly indicates otherwise. In addition, terms such as “include,” “have” or the like are intended to designate the presence of features, numbers, steps, components, or combinations thereof described in the specification, and should not be understood to preclude the possibility of the presence or addition of one or more other features, numbers, steps, components, or combinations thereof. In addition, in the present specification, “connection” is used as a meaning including both indirectly connecting a plurality of components and directly connecting the plurality of components.

Furthermore, in the following description of the present invention, when it is determined that a detailed description of a related known function or configuration may unnecessarily obscure the subject matter of the present invention, the detailed description thereof will be omitted.

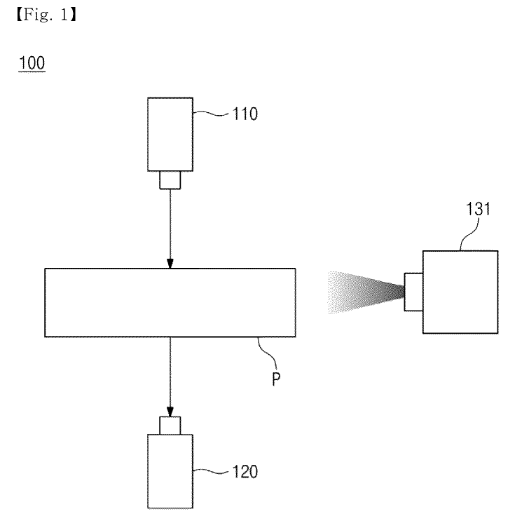

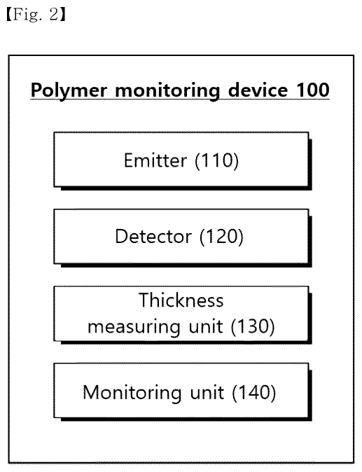

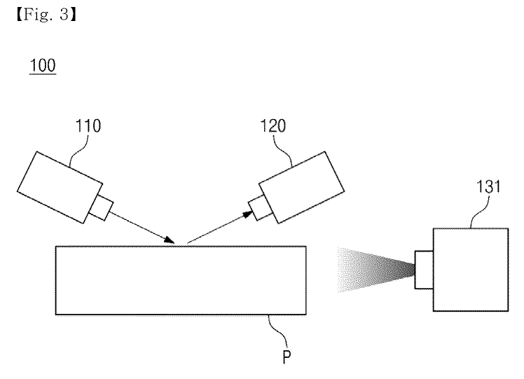

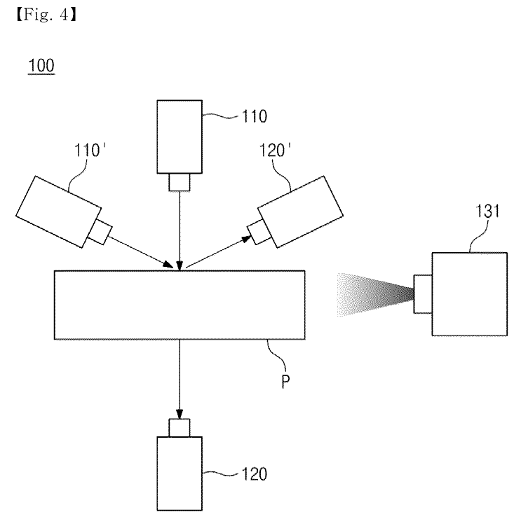

FIG. 1 is a schematic view schematically showing a polymer monitoring device according to one embodiment of the present invention, FIG. 2 is a configuration view showing a polymer monitoring device according to one embodiment of the present invention, FIG. 3 is a schematic view schematically showing a polymer monitoring device according to one modified embodiment of the present invention, and FIG. 4 is a schematic view schematically showing a polymer monitoring device according to another modified embodiment of the present invention.

As shown in FIGS. 1 and 2, a polymer monitoring device 100 according to one embodiment of the present invention may include an emitter 110, a detector 120, and a monitoring unit 140.

The emitter 110 may be a device which generates terahertz waves toward a polymer layer P. To this end, the emitter 110 may be disposed to face the polymer layer P. In this case, the polymer layer P may be in a process of being coated on a substrate (not shown) and being cured. The polymer layer P may be, for example, a functional layer such as an epoxy molding compound (EMC), a photoresist (PR), etc. In addition, the polymer layer P may be a substrate per se. In other words, the polymer layer P may be provided alone without a substrate.

According to one embodiment of the present invention, the emitter 110 and the detector 120 may be provided to be operable in a transmission mode based on an optical path of terahertz waves for the polymer layer P.

To this end, the emitter 110 provided on the polymer layer P may be disposed in a normal direction of the polymer layer P.

According to one embodiment of the present invention, the terahertz wave generated by the emitter 110 and irradiated toward the polymer layer P may be provided as a pulsed type or a continuous wave type.

Here, the pulsed type of terahertz wave contains a large number of frequencies, and thus may have an advantage of being detected at once.

In order to generate the pulsed type of terahertz wave, a femtosecond laser functioning as a pump light for generating the pulsed type of terahertz wave may be irradiated on the emitter 110.

Meanwhile, according to one embodiment of the present invention, the frequency of the terahertz wave generated by the emitter 110 and irradiated on the polymer layer P may be 0. THz1 THz to 10.

As described above, according to one embodiment of the present invention, the emitter 110 and the detector 120 may be provided to be operable in a transmission mode based on an optical path of terahertz waves for the polymer layer P.

To this end, the detector 120 may be disposed at a lower side of the polymer layer P in a normal direction of the polymer layer P, and may be disposed on the same line as the emitter 110 with the polymer layer P interposed therebetween.

Accordingly, the terahertz wave generated by the emitter 110 may pass through the polymer layer P and detected by the detector 120.

In this case, the terahertz wave generated by the emitter 110, passing through the polymer layer P, and detected by the detector 120 may be used to calculate terahertz wave parameter data for simultaneously monitoring the crystallinity and moisture absorption status of the polymer layer P in real time.

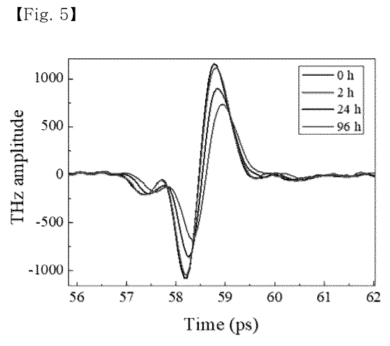

FIG. 5 is a graph showing a relationship between time and terahertz wave amplitude.

Referring to FIG. 5, it was confirmed that moisture absorption of the polymer layer increases over time, and as moisture absorption of the polymer layer increases, the amplitude of the terahertz wave having passed through the polymer layer decreases.

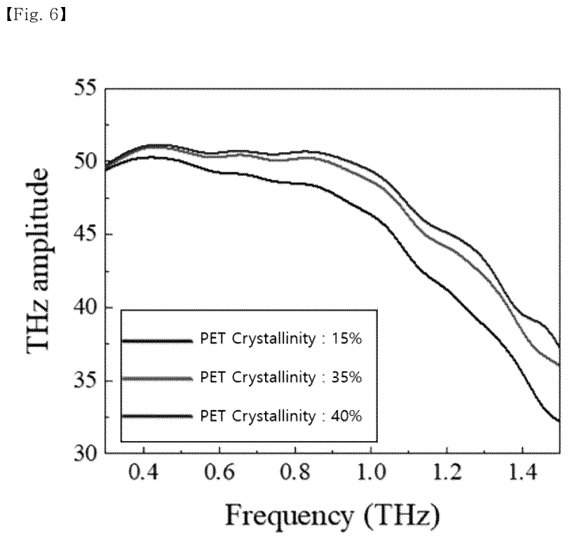

In addition, FIG. 6 is a graph showing a relationship between a frequency of terahertz wave and an amplitude of terahertz wave for each crystallinity of PET, which is a result of fast fourier transform (FFT) of terahertz wave data of FIG. 5.

Referring to FIG. 6, it was confirmed that as the crystallinity of PET constituting the polymer layer decreases, the amplitude of the terahertz wave in a high frequency domain decreases.

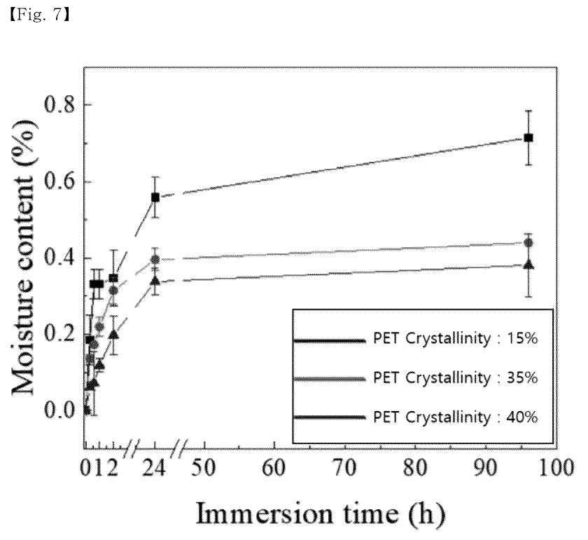

In addition, FIG. 7 is a graph showing a relationship between time and moisture content for each crystallinity of PET.

Referring to FIG. 7, it was confirmed that the moisture content of the PET constituting the polymer layer increases over time, and the lower the crystallinity of the PET, the more the moisture content increases over time.

Meanwhile, according to one embodiment of the present invention, one or two or more emitters 110 and one or two or more detectors 120 may be provided. In this case, when two or more emitters 110 and two or more detectors 120 are provided, respectively, the number of emitters may correspond to the number of detectors to form a pair.

In addition, according to one embodiment of the present invention, the emitter 110 and the detector 120 may target a single pixel or a plurality of pixels among the pixels partitioned on the polymer layer. In this case, when the emitter 110 and the detector 120 target the plurality of pixels, the emitter 110 and the detector 120 may scan the plurality of pixels. To this end, the emitter 110 and the detector 120 may be provided to be movable forward, backward, left, and right.

Meanwhile, as shown in FIG. 3, according to one modified embodiment of the present invention, the emitter 110 and the detector 120 may be provided to be operable in a reflection mode based on an optical path of terahertz waves for the polymer layer P.

Accordingly, the detector 120 may be disposed to be symmetrical to the emitter 110 with respect to a normal direction of the polymer layer P. For example, when the emitter 110 is disposed to be inclined by 30 degrees in the normal direction of the polymer layer P, the detector 120 may be correspondingly disposed to be inclined by −30 degrees in the normal direction of the polymer layer P.

As such, when the emitter 110 and the detector 120 are provided to be operable in the reflection mode, according to one modified embodiment of the present invention, the detector 120 may detect a terahertz wave generated by the emitter 110 and reflected from a surface of the polymer layer P.

For example, when the emitter 110 and the detector 120 are disposed in the reflection mode having an inclination of 30 degrees on both left and right sides with respect to the normal direction of the polymer layer P, the terahertz wave generated by the emitter 110 and incident on the surface of the polymer layer P at an angle of 60 degrees may be reflected at an angle of −60 degrees and received by the detector 120.

In this case, the inclinations and directions of the emitter 110 and the detector 120 may be precisely adjusted. For example, the emitter 110 and the detector 120 which are precisely adjusted may have six degrees of freedom. The six degrees of freedom of the emitter 110 and the detector 120 may be three axes of x, y, and z directions and rotation directions with respect to each axis.

In addition, as shown in FIG. 4, according to another modified embodiment of the present invention, a first emitter 110′ and a first detector 120′ may be provided to be operable in a reflection mode based on an optical path of terahertz waves for the polymer layer P.

Moreover, according to another modified embodiment of the present invention, a second emitter 110 and a second detector 120 may be provided to be operable in a transmission mode based on an optical path of terahertz waves for the polymer layer P.

In other words, according to another modified embodiment of the present invention, a polymer monitoring device 100 may operate in a multiple mode in which the reflection mode of the first emitter 110′ and the first detector 120′ and the transmission mode of the second emitter 110 and the second detector 120 are combined.

To this end, the first emitter 110′ and the first detector 120′ may be disposed to be inclined while being symmetrical to each other on both sides with respect to the normal direction of the polymer layer P.

For example, when the first emitter 110′ and the first detector 120′ are disposed in the reflection mode having an inclination of 30 degrees on both left and right sides with respect to the normal direction of the polymer layer P, the terahertz wave generated by the first emitter 110′ and incident on the surface of the polymer layer P at an angle of 60 degrees on the basis of the surface of the polymer layer P may be reflected at an angle of −60 degrees and received by the first detector 120′.

In addition, the second emitter 110 and the second detector 120 may be disposed at upper and lower sides of the polymer layer P with the polymer layer P interposed therebetween to face each other in the normal direction of the polymer layer P.

Accordingly, the terahertz wave generated by the second emitter 110 may pass through the polymer layer P and may be detected by the second detector 120.

Referring back to FIG. 2, the polymer monitoring device 100 according to one embodiment of the present invention may further include a thickness measuring unit 130.

The thickness measuring unit 130 may be a device for measuring the thickness of the polymer layer P. The thickness information of the polymer layer P measured by the thickness measuring unit 130 may be used to calculate optical property data of the polymer layer P.

Here, the optical property data of the polymer layer P may include a refractive index (η) of the polymer layer P and an extinction coefficient of the polymer layer P.

According to one embodiment of the present invention, the thickness measuring unit 130 may measure the thickness of the polymer layer P in a contact manner or a non-contact manner. In this case, when the thickness of the polymer layer P is measured in the contact manner, the polymer layer P may be damaged, and thus it may be more preferable to measure the thickness of the polymer layer P in the non-contact manner.

According to one embodiment of the present invention, the thickness measuring unit 130 may be provided in a combination type capable of simultaneously measuring the same point as that of the emitter 110 and the detector 120.

Referring to FIG. 1, for example, the thickness measuring unit 130 may photograph a side surface of the polymer layer P through the camera 131 while the emitter 110 generates a terahertz wave toward the polymer layer P and the detector 120 detects the terahertz wave passing through the polymer layer P.

In addition, the thickness measuring unit 130 may measure the thickness of the polymer layer P by analyzing a side surface picture of the polymer layer P photographed through the camera 131.

Meanwhile, the thickness measuring unit 130 may be provided in a type separated from the emitter 110 and the detector 120.

In other words, when the terahertz wave information is completely obtained through the emitter 110 and the detector 120 provided in the transmission mode, the polymer monitoring device 100 according to one embodiment of the present invention may cause the emitter 110 and the detector 120 to be removed and the camera 131 may be installed for obtaining thickness information of the polymer layer P, thereby measuring the thickness of the polymer layer P.

In this case, according to one embodiment of the present invention, after the terahertz wave information is completely obtained through the emitter 110 and the detector 120, a substrate (not shown) having the polymer layer P coated on a surface thereof or the polymer layer P provided alone may be moved to a place where the camera 131 is installed on a stage (not shown).

According to one embodiment of the present invention, after the emitter 110 generates a terahertz wave toward the polymer layer P and the detector 120 detects the terahertz wave emitted by passing through the polymer layer P, the thickness measuring unit 130 may photograph a side surface of the polymer layer P through the camera 131 and analyze a side surface picture of the polymer layer P photographed through the camera 131 to measure the thickness of the polymer layer P.

In this case, the thickness measuring unit 130 may measure the thickness of the polymer layer P through a laser sensor (not shown) in addition to the camera 131. The thickness measuring unit 130 may irradiate an electromagnetic wave such as a laser, white light or the like on the polymer layer P through the laser sensor (not shown), and may measure the thickness of the polymer layer P by analyzing the electromagnetic wave emitted by being reflected from the polymer layer P after being irradiated.

According to one embodiment of the present invention, the thickness measuring unit 130 may measure the thickness of the polymer layer P by using both the camera 131 and the laser sensor (not shown).

As such, when both the camera 131 and the laser sensor (not shown) are used to measure the thickness of the polymer layer P, the accuracy of thickness measurement may be improved, thereby securing reliability.

In addition, the thickness measuring unit 130 may measure the thickness of the polymer layer P in a contact manner such as a micrometer.

Referring back to FIG. 2, the monitoring unit 140 may calculate terahertz wave parameter data through the terahertz wave detected by the detector 120 while the polymer layer S is being cured.

The terahertz wave parameter data may include a terahertz wave relative amplitude (Eᵣ) and a peak amplitude ratio (\tilde{E}ᵣ) calculated through equation 1 below:

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Here, the E₀ may be a time domain amplitude or frequency domain amplitude of the terahertz waves before the polymer layer absorbs moisture, the Eₜ may be a time domain amplitude or frequency domain amplitude of the terahertz waves having passed through the polymer layer that has absorbed moisture, the \tilde{B}_{high} may be a peak amplitude in a high frequency domain of a frequency domain signal of the terahertz waves having passed through the polymer layer, and \tilde{B}_{low} may be a peak amplitude in a low frequency domain. Thus, both the terahertz wave relative amplitude (Eᵣ) and the peak amplitude ratio (\tilde{E}ᵣ) may be obtained from the frequency domain data used for calculating the peak amplitude ratio (\tilde{E}ᵣ).

According to one embodiment of the present invention, the monitoring unit 140 may simultaneously monitor the crystallinity and moisture absorption status of the polymer layer P in real time, based on the terahertz wave parameter data calculated as described above, that is, the terahertz wave relative amplitude (Eᵣ) and the peak amplitude ratio (\tilde{E}ᵣ).

Accordingly, according to one embodiment of the present invention, it may be possible to immediately cope with the occurrence of a problem in the polymer curing process such as an abnormality in the polymer, an abnormality in curing equipment or the like.

In other words, according to embodiments of the present invention, it may be possible to confirm in real time whether curing needs to be further performed or less performed, or whether moisture is excessive during the process, thus taking active measures to improve a yield during the process.

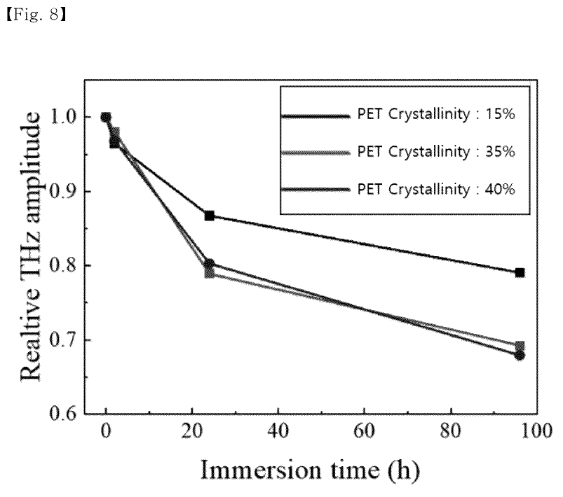

FIG. 8 is a graph showing a relationship between time and terahertz wave relative amplitude for each crystallinity of PET.

Referring to FIG. 8, before the polymer layer absorbs moisture, it was confirmed that the terahertz wave relative amplitude (Eᵣ) defined as a ratio of the time domain amplitude (E₀) of the terahertz wave and the time domain amplitude (Eₜ) of the terahertz wave having passed through the polymer layer in which moisture was absorbed is reduced as the polymer layer made of PET absorbs moisture, and it was confirmed that a deceleration width of the terahertz wave relative amplitude (Eᵣ) is smaller as the crystallinity of the polymer layer made of PET is lower.

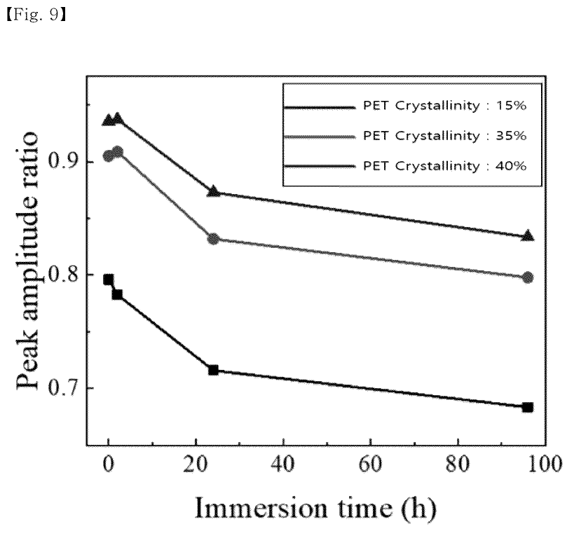

In addition, FIG. 9 is a graph showing a relationship between time and peak amplitude ratio for each crystallinity of PET.

Referring to FIG. 9, it was confirmed that the peak amplitude ratio (\tilde{E}ᵣ) defined as a ratio of the peak amplitude (\tilde{B}_{high}) in the high frequency domain and the peak amplitude (\tilde{B}_{low}) in the low frequency domain among the frequency domain signals of the terahertz wave having passed through the polymer layer is reduced as the polymer layer made of PET absorbs moisture, and it was confirmed that the peak amplitude ratio (\tilde{B}_{low}) is reduced as the crystallinity of the polymer layer made of PET is lower.

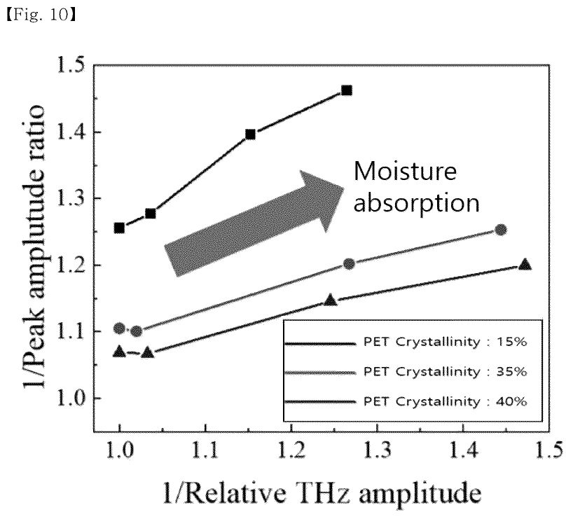

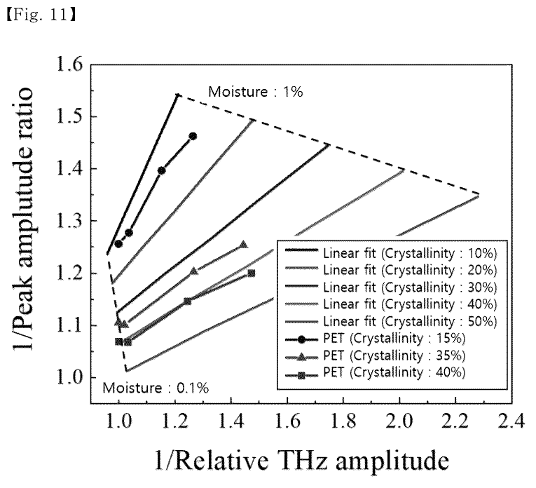

FIGS. 10 and 11 are graphs showing a relationship between terahertz wave relative amplitude and peak amplitude ratio for each crystallinity of PET.

Referring to FIGS. 10 and 11, these graphs show results of simultaneously monitoring changes according to the crystallinity and moisture absorption of the polymer layer by using the terahertz wave relative amplitude (Eᵣ) and the peak amplitude ratio (\tilde{E}ᵣ) which are terahertz wave parameter data calculated through the terahertz waves detected by the detector while the polymer layer is being cured.

Meanwhile, according to one embodiment of the present invention, the monitoring unit 140 may calculate optical physical property data of the polymer layer P through the terahertz wave detected by the detector 120 and the thickness information of the polymer layer P measured by the thickness measuring unit 130.

Here, the optical property data of the polymer layer P may include a refractive index (η) of the polymer layer and an extinction coefficient of the polymer layer.

According to one embodiment of the present invention, the monitoring unit 140 may monitor whether a curing process for the polymer layer P is in a normal process by further considering the calculated optical physical property data of the polymer layer P.

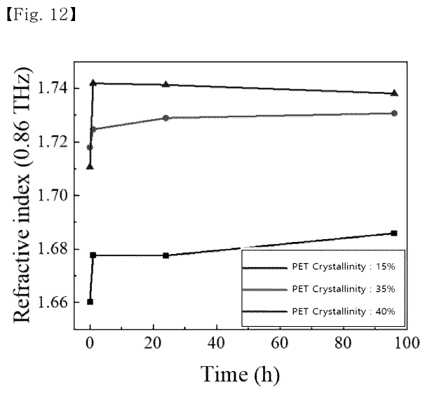

FIG. 12 is a graph showing a relationship between time and relative index for each crystallinity of PET, and shows the optical property results calculated through formula 2 below with respect to a terahertz wave according to crystallinity and moisture absorption status.

$${n}_{s} ( w ) = ∅ ( w ) \times \frac{c}{w \cdot d} + {n}_{air} \qquad [ Equation 2 ]$$

Here, the nₛ may denote a refractive index of the polymer layer at a frequency of 0. THz86, the w may denote each frequency, the ø(w) may denote a phase difference between a terahertz wave having passed through air and a terahertz wave having passed through the polymer layer, the (may denote a speed of light, the d may denote a thickness of the polymer layer, and the nₐᵢᵣ may denote a refractive index of air.

Referring to FIG. 12, it was confirmed that the higher the crystallinity of the polymer layer made of PET, the higher the refractive index at a frequency of 0.86 THz, and it was confirmed that a relative difference in the refractive index according to the crystallinity is maintained even if time has passed.

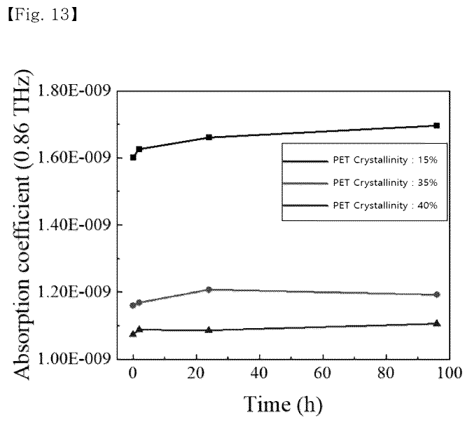

FIG. 13 is a graph showing a relationship between time and extinction coefficient for each crystallinity of PET.

Referring to FIG. 13, it was confirmed that the lower the crystallinity of the polymer layer made of PET, the higher the extinction coefficient at a frequency of 0.86 THz, and it was confirmed that a relative difference in the extinction coefficient according to the crystallinity is maintained even if time has passed.

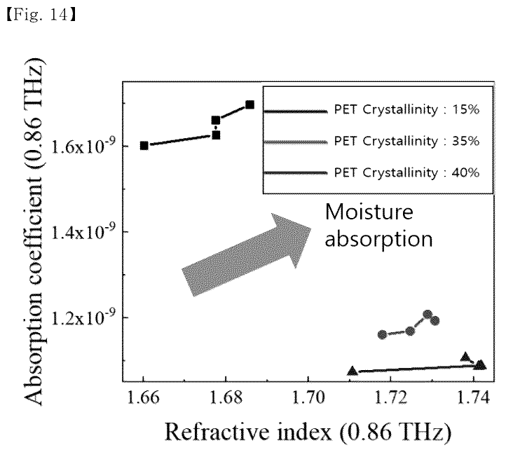

FIG. 14 is a graph showing a relationship between relative index and extinction coefficient for each crystallinity of PET, and shows that it is possible to confirm whether a curing process for the polymer layer is in a normal process by further monitoring a change in the refractive index (η) and the extinction coefficient of the polymer layer, which are optical physical property data of the polymer layer, while simultaneously monitoring the crystallinity and moisture absorption status of the polymer layer P in real time, based on the terahertz wave relative amplitude (Eᵣ) and the peak amplitude ratio (\tilde{E}ᵣ).

In this case, the polymer monitoring device 100 according to one embodiment of the present invention may further include a database DB.

The database DB may store the terahertz wave relative amplitude (Eᵣ) and peak amplitude ratio (\tilde{E}ᵣ), which are terahertz wave parameter data for each process condition, and the refractive index (η) of the polymer layer P and the extinction coefficient of the polymer layer P, which are optical property data of the polymer layer P.

Accordingly, the monitoring unit 140 may extract terahertz wave parameter data for a reference polymer layer having the same process as that of the polymer layer P, which is currently in a curing process, that is, a previously measured polymer layer, from the database DB.

In addition, the monitoring unit 140 may simultaneously monitor the crystallinity and moisture absorption status of the polymer layer P by comparing a change in the extracted terahertz wave parameter data of the reference polymer layer with a change in the terahertz wave parameter data of the polymer layer P calculated through above Equation 1.

According to one embodiment of the present invention, the monitoring unit 140 may compare the change in the extracted terahertz wave parameter data of the reference polymer layer P with the change in the terahertz wave parameter data of the polymer layer P calculated through above Equation 1, and may determine that the polymer layer P is being properly cured when the change in the terahertz wave parameter data of the polymer layer P calculated through above Equation 1 is made within an allowable error range based on the change in the extracted terahertz wave parameter data of the reference polymer layer.

On the contrary, when the change in the terahertz wave parameter data of the polymer layer P calculated through above Equation 1 is out of the allowable error range based on the change in the extracted terahertz wave parameter data of the reference polymer layer, the monitoring unit 140 may determine that a problem has occurred in the polymer curing process such as an abnormality in a polymer material, an abnormality in curing equipment or the like.

When it is determined that a problem has occurred in the polymer curing process, the monitoring unit P may notify a process manager or an operator of a result of monitoring the abnormal occurrence.

Accordingly, the monitoring unit 140 may enable an immediate measure to be taken when a problem occurs in the polymer curing process.

In this case, according to one embodiment of the present invention, the monitoring unit 140 may simultaneously monitor the crystallinity and moisture absorption status of the polymer layer P in real time, thereby enabling an early check when an abnormality occurs in the polymer curing process.

Meanwhile, the monitoring unit 140 may further extract optical property data for a reference polymer layer having the same process as that of the polymer layer P, which is currently in the curing process, from the database DB.

In addition, the monitoring unit 140 may compare the extracted optical property data of the reference polymer layer with the calculated optical property data of the polymer layer P to confirm whether the curing process for the polymer layer P is in a normal process.

As such, according to one embodiment of the present invention, the monitoring unit 140 may monitor the crystallinity and moisture absorption status of the polymer layer P through comparison of terahertz wave parameter data, and may further compare optical property data, thereby improving the accuracy and reliability of monitoring.

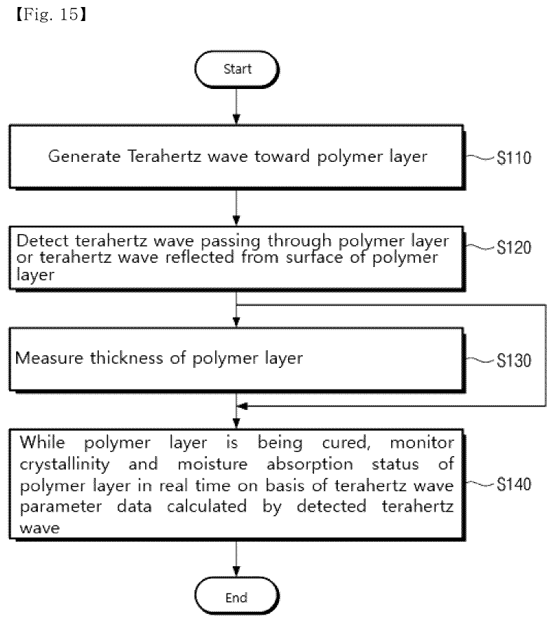

Hereinafter, a polymer monitoring method using terahertz waves according to one embodiment of the present invention will be described with reference to FIG. 15.

FIG. 15 is a flowchart of a polymer monitoring method using terahertz waves according to one embodiment of the present invention in the order of processes.

Referring to FIG. 15, the polymer monitoring method according to one embodiment of the present invention may include S110 to S140.

### S110

In above S110, a terahertz wave may be generated toward the polymer layer P coated on a substrate (not shown) or the polymer layer P provided alone without the substrate.

At this time, in above S110, the terahertz wave may be generated toward the polymer layer P through a transmission mode.

To this end, in above S110, the terahertz wave may be generated so that the terahertz wave may be incident on the polymer layer P in a normal direction of the polymer layer P.

In addition, in above S110, the terahertz wave may be generated toward the polymer layer P through a reflection mode.

To this end, in above S110, the terahertz wave may be generated so that the terahertz wave may be incident on the polymer layer P at an angle of greater than 0° and less than 90° with respect to the polymer layer P.

Then, in above S110, the terahertz wave may be generated toward the polymer layer P through a multi-mode in which the reflective mode and the transmissive mode are combined.

To this end, in above S110, the terahertz wave may be generated so that the terahertz wave may be incident on the polymer layer P in the normal direction of the polymer layer P, and at the same time, the terahertz wave may be generated so that the terahertz wave may be incident on the polymer layer P at an angle of greater than 0° and less than 90° with respect to the polymer layer P.

### S120

In above S120, the terahertz wave generated toward the polymer layer P and having passed through the polymer layer P may be detected.

When the terahertz wave is generated toward the polymer layer P through a transmission mode in above S110, the terahertz wave emitted by having passed through the polymer layer P and a substrate (not shown) or the polymer layer P provided alone may be detected in above S120.

In addition, when the terahertz wave is generated toward the polymer layer P through a reflection mode in above S110, the terahertz wave reflected from a surface of the polymer layer P may be detected in above S120.

When the polymer layer P is not coated on the substrate (not shown) but is provided alone, the transmission mode may be more preferable.

In addition, when the terahertz wave is generated toward the polymer layer P through a multi-mode in which the reflective mode and the transmissive mode are combined in above S110, the terahertz wave emitted by having passed through the polymer layer P may be detected while the terahertz wave reflected from the surface of the polymer layer P may be detected at the same time in above S120.

### S130

In above S130, a thickness of the polymer layer P may be measured. In this case, above S130 may be performed simultaneously with S110 and S120 of generating a terahertz wave toward the polymer layer P and detecting the terahertz wave generated toward the polymer layer P and having passed through the polymer layer P.

In above S130, while the terahertz wave generated toward the polymer layer P and emitted by having passed through the polymer layer P is detected, a side surface of the polymer layer P may be photographed and a side surface picture of the photographed polymer layer P may be analyzed to measure a thickness of the polymer layer P.

As another example, in above S130, while the terahertz wave generated toward the polymer layer P and emitted by having passed through layer the polymer P is detected, an electromagnetic wave such as a laser, white light or the like may be irradiated on the polymer layer P, and the electromagnetic wave reflected from the polymer layer P after being irradiated may be analyzed to measure the thickness of the polymer layer P.

In addition, in above S130, while the terahertz wave generated toward the polymer layer P and then emitted by being reflected from the polymer layer P and the terahertz wave generated toward the polymer layer P and then emitted by having passed through the polymer layer P are simultaneously detected, the thickness of the polymer layer P may be measured by photographing the side surface of the polymer layer P or the thickness of the polymer layer P may be measured by irradiating the electromagnetic wave such as a laser, white light or the like on the polymer layer P.

Meanwhile, above S130 may be performed separately from above S110 and S120.

Accordingly, in above S130, after detecting the terahertz wave generated toward the polymer layer P and having passed through the polymer layer P, for example, the terahertz wave having passed through the polymer layer P or the terahertz wave reflected from the surface of the polymer layer P, the side surface of the polymer layer P may be photographed and a side surface picture of the photographed polymer layer P may be analyzed to measure the thickness of the polymer layer P, or the electromagnetic wave such as a laser, white light or the like may be irradiated on the polymer layer P to measure the thickness of the polymer layer P.

In addition, in above S130, after simultaneously detecting the terahertz wave generated toward the polymer layer P and then emitted by being reflected from the polymer layer P and the terahertz wave generated toward the polymer layer P and then emitted by having passed through the polymer layer P, the thickness of the polymer layer P may be measured by photographing the side surface of the polymer layer P or the thickness of the polymer layer P may be measured by irradiating the electromagnetic wave such as a laser, white light or the like on the polymer layer P.

Here, above S130 may be performed when monitoring whether the process for the polymer layer P is in a normal process by considering the optical property data of the polymer layer P, for example, the refractive index (η) and the extinction coefficient of the polymer layer P in above S140 to be described later, and otherwise, may be omitted.

### S140

In above S140, the terahertz wave parameter data may be calculated through the terahertz wave detected by the detector 120 while the polymer layer S is being cured.

The terahertz wave parameter data may include a terahertz wave relative amplitude (Eᵣ) and a peak amplitude ratio calculated through equation 1 below:

$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$

Here, the E₀ may be a time domain amplitude or frequency domain amplitude of the terahertz waves before the polymer layer absorbs moisture, the Eₜ may be a time domain amplitude or frequency domain amplitude of the terahertz waves having passed through the polymer layer that has absorbed moisture, the \tilde{B}_{high} may be a peak amplitude in a high frequency domain of a frequency domain signal of the terahertz waves having passed through the polymer layer, and \tilde{B}_{low} may be a peak amplitude in a low frequency domain.

In above S140, the crystallinity and moisture absorption status of the polymer layer P may be simultaneously monitored in real time, based on the terahertz wave parameter data calculated as described above, that is, the terahertz wave relative amplitude (Eᵣ) and the peak amplitude ratio (\tilde{E}ᵣ).

Meanwhile, in above S140, optical property data of the polymer layer P may be calculated through the terahertz wave detected through above S120 and the thickness information of the polymer layer P measured through above S130.

Here, the optical property data of the polymer layer P may include a refractive index (η) of the polymer layer and an extinction coefficient of the polymer layer.

In above S140, it may be possible to monitor whether a curing process for the polymer layer P is in a normal process by further considering the calculated optical physical property data of the polymer layer P.

Meanwhile, in above S140, terahertz wave parameter data for a reference polymer layer having the same process as that of the polymer layer P, which is currently in a curing process, that is, a previously measured polymer layer, may be extracted from the database DB.

In addition, in above S140, the crystallinity and moisture absorption status of the polymer layer P may be simultaneously monitored by comparing a change in the extracted terahertz wave parameter data of the reference polymer layer with a change in the terahertz wave parameter data of the polymer layer P calculated through above Equation 1.

According to one embodiment of the present invention, in above S140, the change in the extracted terahertz wave parameter data of the reference polymer layer P may be compared with the change in the terahertz wave parameter data of the polymer layer P calculated through above Equation 1, so as to determine that the polymer layer P is being properly cured when the change in the terahertz wave parameter data of the polymer layer P calculated through Equation 1 is made within an allowable error range based on the change in the extracted terahertz wave parameter data of the reference polymer layer.

On the contrary, in above S140, when the change in the terahertz wave parameter data of the polymer layer P calculated through above Equation 1 is out of the allowable error range based on the change in the extracted terahertz wave parameter data of the reference polymer layer, it may be possible to determine that a problem has occurred in the polymer curing process such as an abnormality in a polymer material, an abnormality in curing equipment or the like.

Meanwhile, in above S140, it may be possible to further extract optical property data for a reference polymer layer having the same process as that of the polymer layer P, which is currently in the curing process, from the database DB.

In addition, in above S140, the extracted optical property data of the reference polymer layer may be compared with the calculated optical property data of the polymer layer P to check whether the curing process for the polymer layer P is in a normal process.

As such, in above S140, it may be possible to monitor the crystallinity and moisture absorption status of the polymer layer P through comparison of terahertz wave parameter data, and to further compare optical property data, thereby improving the accuracy and reliability of monitoring.

Although the present invention has been described in detail using preferred embodiments, the scope of the present invention is not limited to specific embodiments and should be interpreted by the appended claims. In addition, it should be understood by those skilled in the art that many modifications and variations are possible without departing from the scope of the present invention.

1. A polymer monitoring device using terahertz waves comprising:
an emitter for generating terahertz waves toward a polymer layer;
a detector for detecting terahertz waves generated by the emitter and passing through the polymer layer or terahertz waves generated by the emitter and reflected from a surface of the polymer layer; and
a monitoring unit which, while the polymer layer is being cured, simultaneously monitors crystallinity and moisture absorption status of the polymer layer in real time on the basis of terahertz wave parameter data calculated by the terahertz waves detected by the detector, wherein the terahertz wave parameter data include a terahertz wave relative amplitude (Eᵣ) and a peak amplitude ratio (\tilde{E}ᵣ) calculated through equation 1 below:
$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$
wherein the E₀ is a time domain amplitude or frequency domain amplitude of the terahertz waves before the polymer layer absorbs moisture, the Eₜ is a time domain amplitude or frequency domain amplitude of the terahertz waves having passed through the polymer layer that has absorbed moisture, the \tilde{B}_{high} is a peak amplitude in a high frequency domain of a frequency domain signal of the terahertz waves having passed through the polymer layer, and \tilde{B}_{low} is a peak amplitude in a low frequency domain.

2. The polymer monitoring device using terahertz waves of claim 1, wherein the emitter and the detector are provided to be operable in any one measurement mode of a transmission mode, a reflection mode, and a multi-mode in which the transmission mode and the reflection mode are combined, based on an optical path of the terahertz wave for the polymer layer.

3. The polymer monitoring device using terahertz waves of claim 1, wherein at least one emitter and at least one detector are provided such that a number of emitters corresponds to a number of detectors.

4. The polymer monitoring device using terahertz waves of claim 1, wherein the emitter and the detector target a single pixel or a plurality of pixels among the pixels partitioned on the polymer layer, in which when the plurality of pixels are targeted, the plurality of pixels are scanned.

5. The polymer monitoring device using terahertz waves of claim 1, wherein the terahertz wave is provided as a pulsed type or a continuous wave type.

6. The polymer monitoring device using terahertz waves of claim 1, wherein a frequency of the terahertz wave is 0.1 THz to 10 THz.

7. The polymer monitoring device using terahertz waves of claim 1, further comprising:
a thickness measuring unit, wherein the thickness measuring unit measures a thickness of the polymer layer in a non-contact manner.

8. The polymer monitoring device using terahertz waves of claim 7, wherein the thickness measuring unit measures the thickness of the polymer layer by photographing a side surface of the polymer layer through a camera and analyzing a side surface picture of the photographed polymer layer.

9. The polymer monitoring device using terahertz waves of claim 7, wherein the monitoring unit monitors whether a curing process for the polymer layer is in a normal process by further considering optical physical property data of the polymer layer calculated through the terahertz wave detected by the detector and thickness information of the polymer layer measured by the thickness measuring unit.

10. The polymer monitoring device using terahertz waves of claim 9, wherein the optical property data of the polymer layer includes a refractive index (η) of the polymer layer and an extinction coefficient of the polymer layer.

11. The polymer monitoring device using terahertz waves of claim 9, further comprising:
a database, wherein the database stores the terahertz wave parameter data for each process condition and the optical property data of the polymer layer, and
the monitoring unit extracts terahertz wave parameter data and optical property data for a reference polymer layer having a same process as a process of a polymer layer, which is currently in a curing process, from the database, and compares the extracted terahertz wave parameter data and optical property data for the reference polymer layer with the calculated terahertz wave parameter data or optical property data for the polymer layer to simultaneously monitor crystallinity and moisture absorption status of the polymer layer.

12. A polymer monitoring method using terahertz waves comprising:
generating terahertz waves toward a polymer layer;
detecting terahertz waves passing through the polymer layer or terahertz waves reflected from a surface of the polymer layer; and
while the polymer layer is being cured, simultaneously monitoring crystallinity and moisture absorption status of the polymer layer in real time on the basis of terahertz wave parameter data calculated by the terahertz waves detected by the detecting of the terahertz waves, wherein the terahertz wave parameter data include a terahertz wave relative amplitude (Eᵣ) and a peak amplitude ratio (\tilde{E}ᵣ) calculated through equation 1 below:
$${E}_{r} = \frac{{E}_{t}}{{E}_{0}} , {\tilde{E}}_{r} = \frac{{\tilde{E}}_{low}}{{\tilde{E}}_{high}} \qquad [ Equation 1 ]$$
wherein the E₀ is a time domain amplitude or frequency domain amplitude of the terahertz waves before the polymer layer absorbs moisture, the Eₜ is a time domain amplitude or frequency domain amplitude of the terahertz waves having passed through the polymer layer that has absorbed moisture, the \tilde{B}_{high} is a peak amplitude in a high frequency domain of a frequency domain signal of the terahertz waves having passed through the polymer layer, and \tilde{B}_{low} is a peak amplitude in a low frequency domain.

13. The polymer monitoring method using terahertz waves of claim 12, further comprising:
measuring a thickness of the polymer layer, wherein the measuring of the thickness of the polymer layer includes photographing a side surface of the polymer layer and analyzing a side surface picture of the photographed polymer layer to measure the thickness of the polymer layer.

14. The polymer monitoring method using terahertz waves of claim 13, wherein the monitoring includes monitoring whether a curing process for the polymer layer is in a normal process by further considering optical physical property data of the polymer layer calculated through the terahertz wave detected by the detecting of the terahertz wave and the thickness information of the polymer layer measured by the measuring of the thickness of the polymer layer.
